(19) United States
(12) Patent Application Publication
(10) Pub. No.: US 2026/0136035 A1
(43) Pub. Date: May 14, 2026

(54) SYSTEMS AND METHODS FOR DECODED FRAME AUGMENTATION FOR VIDEO CODING FOR MACHINES

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US)

(73) Assignee: OP Solutions LLC, Amherst, MA (US)

(21) Appl. No.: 19/434,433

(22) Filed: Dec. 29, 2025

Related U.S. Application Data
(63) Continuation of application No. PCT/US2024/007083, filed on Jun. 30, 2024.
(60) Provisional application No. 63/524,455, filed on Jun. 30, 2023.

(51) Int. Cl. H04N 19/44; G06V 10/40; G06V 10/82; G06V 20/40; H04N 19/159; H04N 19/172; H04N 19/196

(52) U.S. Cl. CPC H04N 19/44; G06V 10/40; G06V 10/82; G06V 20/46; H04N 19/159; H04N 19/172; H04N 19/196

(57) ABSTRACT

The present systems and methods for video decoding for machine processing extract features and image statistics from the decoded bitstream and evaluate the image statistics to predict whether augmentation of a frame will enhance task performance and generate at least one parameter for selectively applying an augmentation process. The parameter is applied to selectively alter at least a portion of a frame to enhance task performance by the machine processing the decoded bitstream.

### STATEMENT OF RELATED CASES

The present application claims the benefit of priority to U.S. provisional application Ser. No. 63/524,455, filed on Jun. 30, 2023, and entitled “System and Method for Decoded Frame Augmentation for Video Coding for Machines,” the disclosure of which is hereby incorporated by reference in its entirety.

### BACKGROUND OF THE DISCLOSURE

In recent times, a significant portion of all the images and videos that are recorded in the field are consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines are in development in addition to already established standards such as Compact Descriptors for Visual Search, and Compact Descriptors for Video Analytics. Solutions that improve efficiency compared to the classical image and video coding techniques are needed.

Video Coding for Machines (VCM) is the process of compressing image/video information for machine consumption. As used herein, VCM is not limited to any particular protocol or standard and is intended to broadly convey compression and decompression of data for machine consumption. Machine consumption is the process of machines consuming information, in this case in the form of images/video. This can include object detection and segmentation tasks. Current VCM systems follow the following architecture: video/images are captured by a digital camera or recording device, video/image information is compressed using a device or software called a codec (compression-decompression). The compressed image/video information is sent to a receiving device where the image/video information is decompressed and interpreted by a machine. The compression can be performed using traditional block-based video encoders such as versatile video coding (VVC), neural-network based compression, or hybrid of traditional coding and neural-network based compression.

FIG. 1 is a block diagram of a system for encoding and decoding video for machine-based applications. Video coding in the system of FIG. 1 can include any standard video encoder and/or encoding techniques such as, for example, Advanced Video Codec (AVC), Versatile Video Coding (VVC), or High Efficiency Video Coding (HEVC).

Still referring to FIG. 1, frames from decoded videos at the receiver are used as input to the trained neural networks to perform tasks such as object detection, object segmentation, and object tracking. At the encoder side, the system typically includes an image capture system 105, such as a video camera, or other system for image capture including LIDAR and other non-visual “image” data or high-bandwidth machine readable data. The system further includes an image/video compression system 110. An encoded bitstream is transmitted over a suitable transmission channel to a receiving machine. The received bitstream is received by a decompression block, which substantially inverts the compression process and passes the decompressed bitstream to a machine analysis system 120. In general, applying compression is a lossy process that can degrade the quality of the compressed video relative to the source and may impact the performance of machine tasks. Higher levels of compression will be more efficient for transmission but could lead to larger degradation in quality and degradation in machine task performance. Methods to improve the task performance without increasing the size of the compressed video will improve VCM applications and services.

Conventional approaches unfortunately, may require a massive video transmission especially in applications having multiple cameras or other high-bandwidth endpoints, which may take significant time for efficient and fast real-time analysis and decision-making. In certain embodiments, a VCM approach may resolve this problem by both encoding video and extracting some features at a transmitter site and then transmitting a resultant encoded bit stream to a VCM decoder. At a decoder site, video may be decoded for human vision and features may be decoded for machines. As used herein, the term VCM refers broadly to video coding and decoding for machine consumption and is not limited to a specific proposed protocol.

A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like.

At a decoder site it will be appreciated that video may be decoded for human vision and features may be decoded for machines. Systems which provide data, such as video, for both human vision and for machine consumption are sometimes referred to as hybrid systems. The systems and methods disclosed herein are intended to apply to machine-based systems as well as hybrid systems.

### SUMMARY OF THE DISCLOSURE

A decoder for a video coding for machine consumption employing frame augmentation to enhance task performance includes a video decoder receiving an encoded bitstream and providing a decoded bitstream comprising a plurality of frames. A feature extractor module extracts features and image statistics from the decoded bitstream for machine processing. An augmentation module applies the extracted features and image statistics and selectively alters at least a portion of at least one frame of the decoded bitstream to enhance task performance by the machine processing the decoded bitstream.

Unless augmentation is applied to all frames, the decoder preferably includes a prediction module interposed between the feature extractor module and the augmentation module. The prediction model uses the extracted features and image statistics and provides at least one parameter to the augmentation model indicating whether to selectively apply augmentation for at least one frame of the decoded bitstream. In certain embodiments, the prediction model includes a trained neural network evaluating decoded frame attributes including at least one of quantization parameters, motion parameters, block partitioning, and header information describing encoder parameters.

In some embodiments, selectively applying augmentation further comprises selectively adjusting the magnitude of feature augmentation for at least one frame of the decoded bitstream. In certain embodiments where a frame includes a plurality of coding blocks, the augmentation module preferably performs at least one of sharpening and blurring boundaries between adjacent coding blocks.

The extractor module extracts at least one image statistic from the decoded bitstream. Exemplary image statistics includes at least one of statistics related to blur, brightness, color, BRISQUE, resolution, contrast, and compression.

In certain embodiments disclosed herein, the prediction module further comprises operations including acquiring image statistics from the extractor module, performing image augmentation on a current frame, performing object detection on a augmented current frame, determining image mAP higher and mAP lower parameters for the augmented frame, determining at least one image statistics score; and applying the image statistics and image statistics score to a trained prediction model and determining at least one mAP performance prediction.

### DESCRIPTION OF THE FIGURES

Embodiments of the present disclosure are described in connection with the following figures, in which:

FIG. 1 is a block diagram showing a system for video coding and decoding for machine-based applications;

FIG. 2 is a block diagram illustrating an exemplary embodiment of a video coding and decoding system employing frame augmentation in accordance with the present disclosure;

FIG. 3 is a block diagram illustrating an exemplary embodiment of a video coding and decoding system employing frame augmentation with latent feature exploitation in accordance with the present disclosure;

FIG. 4 is a block diagram illustrating an example of feature exploitation in accordance with the present disclosure.

FIG. 5 is a schematic diagram illustrating a prediction setup in an exemplary embodiment of a video coding and decoding system employing frame augmentation in accordance with the present disclosure.

FIG. 6 illustrates another exemplary process of optimizing a loss function for video coding for machines;

FIG. 7 is a simplified block diagram illustrating an exemplary machine-learning processes in accordance with the present embodiments;

FIG. 8 is a block diagram illustrating an exemplary embodiment of a video decoder;

FIG. 9 is a block diagram illustrating an exemplary embodiment of a video encoder;

FIG. 10 is a flow diagram illustrating an exemplary method of optimizing a loss function with a rate-distortion cost for video coding for machines; and

FIG. 11 is a block diagram of a computing system that can be used to implement any one or more of the methodologies disclosed herein and any one or more portions thereof.

### DETAILED DESCRIPTION OF THE EMBODIMENTS

Neural networks for video encoding and decoding applications are typically trained using compressed images and videos. Many features in the images used in training may impact object detection models during training. In addition to content features such as objects present in the image, these features may include characteristics of the compression algorithms used to compress the training images (JPEG, HEVC, etc.), resolution, aspect ratio, as well as any other features that can influence a neural network's ability to make predictions. Other image statistics such as blur, brightness, color, BRISQUE, contrast, compression information etc. or any other image information that may impact the training of neural networks, may impact the performance of trained networks during both inference and task performance phases.

The compression methods commonly used to compress the images and video in VCM systems may degrade or remove the image features and degrade the performance of the neural network used for a machine task. The present systems and methods employ the use of image and video statistics and latent image features for the purpose of increasing machine task performance, such as object detection performance as one illustrative example. Whether a decoded frame augmentation method improves machine task performance depends on the content and coding of the decoded frames. Decoded frame attributes such as quantization parameters used, motion parameters used, block partitioning information, and header information such as picture parameter sets used in HEVC that describe encoder parameters, can be used to decide when decoded frame augmentation (“DFA”) should be applied. Frames decoded at a receiver site can be augmented to further enhance machine task performance and then input to the neural networks to improve machine task performance.

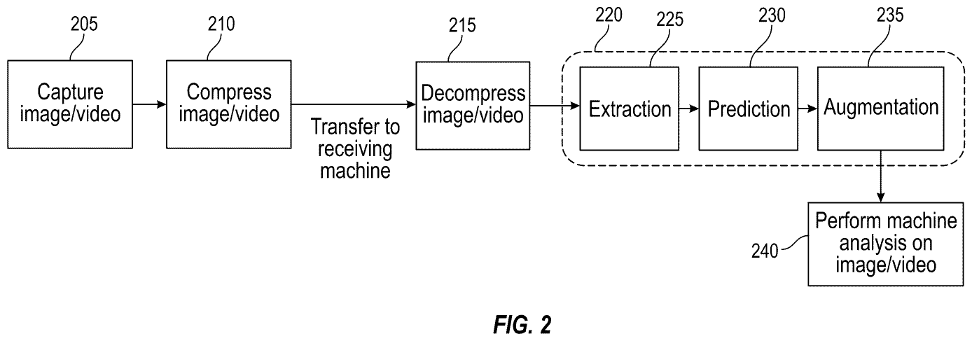

FIG. 2 is a block diagram illustrating an exemplary embodiment of a video coding and decoding system employing frame augmentation in accordance with the present disclosure. At an encoding site, images/video or similar data (e.g. Lidar) are captured by image capture system 205 and compressed 205 to create an encoded bitstream. The encoded bitstream is transmitted over a channel to a receiving site where the encoded bitstream is decoded, typically by performing inverse operations to the encoding process in decompress/decode process 215. Conventional encoding/decoding techniques can be employed in compression 210 and decompression 215 such as those used in advanced video coding protocols including HEVC, AV1 and VVC.

Referring to FIG. 2, the present methods are applied to the decoded bitstream output from decompress/decode process 215 to create the latent features and then input those latent features to the neural networks to improve machine task performance. This process of decoded frame augmentation 220 can generally be divided into 3 stages: extraction 225, prediction 230, and augmentation 235. The augmented bitstream is then passed to the machine-based system 240 for analysis or task performance.

Extraction 225 is the process of computing image/video statistics using the decoded frame data; some commonly used image/video statistics as previously mentioned are blur, brightness, color, BRISQUE, resolution and contrast and others (referred to as image statistics). Image/video statistics can take the form of any information derived from images/video.

DFA can be selectively applied to an image or frame and the level of augmentation can also be varied. Prediction 230 is used to determine whether DFA is needed for a particular frame. Prediction 230 can be performed using statistical modeling, machine learning, thresholding, or any other form of deriving predictions from image/video statistics for the purpose of determining whether augmentation should be performed and if so, how much. Statistical modeling can include computing image statistics on the decoded frames and use threshold on such statistical features to determine whether DFA should be applied. For example, if blur feature value is over certain threshold value then DFA should be applied. In another approach, if the frame compression uses smaller block sizes, which could indicate the presence of smaller objects in the frame, then DFA method could be applied. Similarly, other bitstream parameters could indicate when DFA is applied. If quantization parameters used in the compressed video and images are larger than a threshold, then certain DFA method can be applied, such as sharpening and or smoothing of the abrupt edges between coding blocks, which are typically 8×8 in the case of JPEG. Similarly, if quantization parameters used in the compressed video and images are smaller than a threshold then DFA methods such as blurring by applying low pass filtering and introducing edges between the coding blocks can be applied.

Deblocking parameters used in the compression method and typically included in the compressed video bitstream are another type of parameters in the compressed video bitstream that can trigger the application of DFA. Strength of edges at the block boundaries is another parameter that can be used.

Augmentation 235 typically follows the prediction stage, here an augmentation of the image/video takes place, an augmentation being a change to the image/video for performance gain. Alternatively, augmentation 235 can be applied without the prediction step, for example in a use case where augmentation is always applied. Augmentation 235 is the process such as applying a filter that modifies portions of a decoded frame or an entire decoded frame. Sharpening a decoded frame is an example of DFA. Such sharpening may be applied to only certain portions of a decoded image. Portions to sharpen may be determined using the block sizes used in compression. For example, only those portions of a decoded frame that are coded with block size 8×8 or smaller may be selected as the portion of the decoded frame for DFA. Another example of DFA is compressing and then decompressing a frame or a portion of a frame using image compression algorithm such as JPEG. A digital filter or process that approximates the combined encoding and decoding using JPEG may be used. For example, applying DCT of size 8×8 to each block of image or image portion, quantizing the block, and then dequantizing the block, followed by inverse DCT would approximate JPEG encoding and decoding.

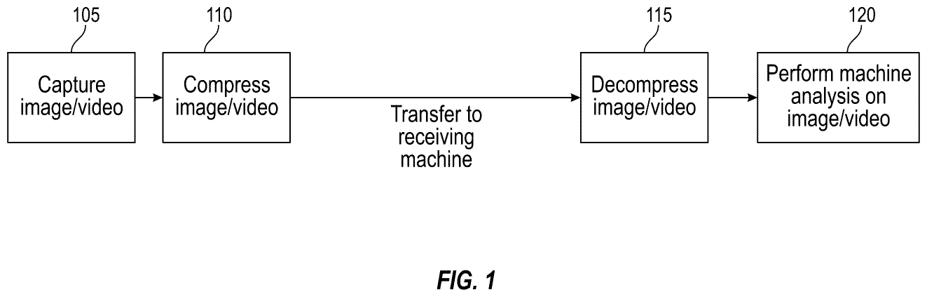

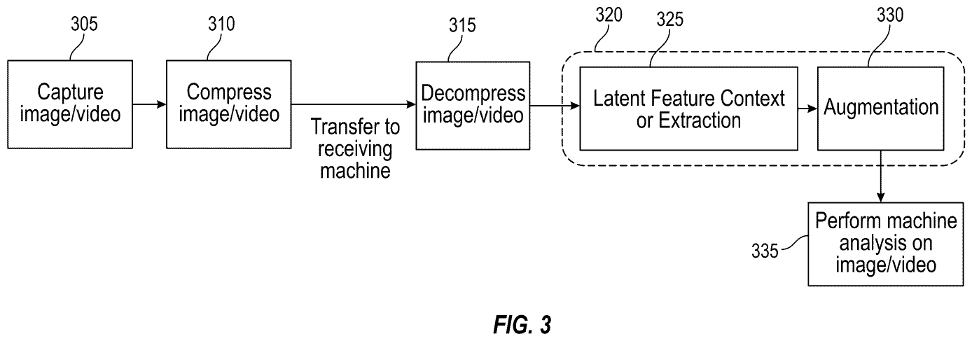

FIG. 3 illustrates a further exemplary embodiment of the present systems and methods. The image acquisition side includes image capture system 305 and compression system 310, which can take the form described above in FIGS. 1 and 2. At a machine site, the encoded bitstream is received by decompress/decoder 315, which can take the form described above in FIGS. 1 and 2. DFA block 320 include latent feature context or extraction 325 and augmentation 330. The DFA augmented images are provided to machine analysis 335.

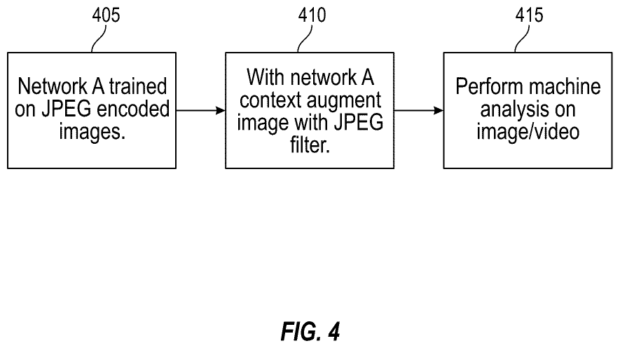

FIG. 4 is a flow diagram further illustrating the process of exploiting latent features in accordance with the current systems and methods. Latent features are introduced to neural networks 405 from features present in their training set. These latent features can be utilized to increase neural network performance by augmenting images being used in the neural network to be more like those used in the training set. A neural network is first trained on a set of encoded JPEG images 405. Using the trained network, perform context augmentation of images with a JPEG filter 410. Machine analysis can then be performed on the augmented images 415.

For example, a neural network trained with the JPEG images will “learn” features that are augmented by the JPEG compression, such as 8×8 block boundaries, low frequency texture as a result of quantization, etc. Images that are not compressed by the JPEG algorithm do not necessarily contain aforementioned features. Augmenting those images, such as by adding low-pass filtering and rectangular boundaries, may increase the performance of the task network. Network detections of the augmented images will typically better align with the trained detections which included aforementioned features, as compared with the images that do not contain those features.

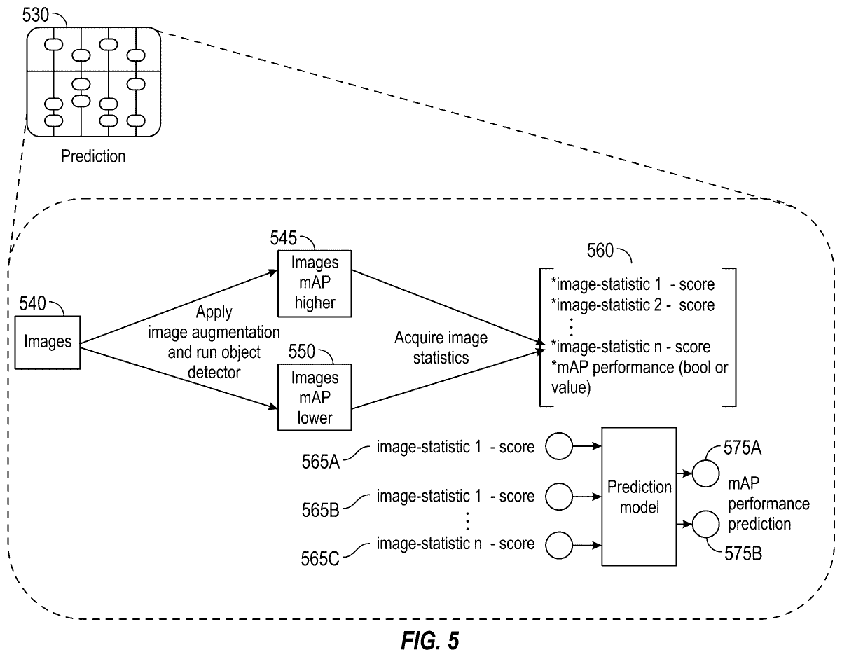

FIG. 5 is a schematic diagram further illustrating an exemplary prediction operation, such as used in prediction block 230 in FIG. 2. Prediction can come in many forms; when determining how and when augmentations will be performed statistical analysis, thresholding, or machine learning approaches can be utilized to predict if augmentations are needed and if so, to what degree.

Mean Average Precision (mAP) is commonly used to analyze the performance of object detection and segmentation systems. For a given augmentation, the mAP of a machine task may increase or decrease compared to mAP of machine task using a decoded frame without augmentation. A model is trained by identifying whether augmentation produces lower, higher, of same mAP. This data is used in a statistical model or to train a neural network which is used to predict whether DFA improves machine task performance. Such a model can also take as input parameters from the compressed video bitstream such as block sizes, quantization parameters, deblocking parameters, and motion parameters.

In FIG. 5, images 540 are processed by augmentation and passed through an appropriate object detector to generate images mAP higher 545 and mAP lower 550 which image statistics 560 are acquired. The image statistics 560 and image statistics scores 565 a-c are applied to a prediction model 570 to generate mAP performance predictions 575A and 575B. The image statistics scores 565a-c can be calculated as normalized values from the ranges of given statistics, such as commonly used image/video statistics including, but not limited to, blur, brightness, color, BRISQUE, resolution and contrast and others. For example, the blur level of the image might be represented in the range of [0, 5], and the normalized value will be in the range [0, 1], the BRISQUE's typical range is [0, 100] and can be normalized to the range [0, 1]. Normalized scores are fed as inputs to the prediction model, which outputs the binary prediction of a higher or lower mAP score. The model can be implemented as a simple logistic regression fitting function, or as a neural network. It is expected that an image with the blurriness level similar to the average blurriness level of the training image (the blurriness of which results from the JPEG compression) will produce higher mAP score.

Compressed video bitstreams contain features that can be used to determine whether frame augmentation should be performed at the receiver. Bitstream parameters such as a quantization parameter that is indicative of compressed image quality. If parameters indicate higher quality, then decoded frame augmentation (DFA) can be skipped. Applications can determine thresholds for quality parameters to trigger DFA. Similarly, use of certain coding modes could trigger DFA. If a frame is encoded using large block sizes, then DFA may be applied. A threshold on number of blocks of a given size may also trigger DFA (e.g., if area covered by large blocks>50% of frame area).

VCM bitstreams can explicitly include headers (for example in slice header of a video or something similar to a frame header) to signal the use of DFA.

Sample frame header:

| | No. bits |
|---|---|
| slice_header( ){ | |
| ... | |
| use_DFA | 1 |
| if(use_DFA){ | |
| DFA_type | 7 |
| DFA_parameters_present | 1 |
| if(DFA_parameters_present){ | |
| Parameter_count | 7 |
| for(i = 0; i < Parameter_count; i++){ | |
| Parameter[i] | 32 |
| } | |
| } | |
| } | |
| } | |

use_DFA - 1 one-bit value. A value of 1 indicates DFA must be applied. A value of 0 indicates no DFA.
DFA_type - predefined type of DFA
DFA_parameters_present - A value of 1 indicates DFA specific parameters are present. A value of 0 indicates no DFA parameters are present.
Parameter_count - number of parameters present.
Parameter[i] - i^{th} parameter that is specific to the DFA type signaled.

While video is described as a primary application, it will be appreciated that other input data streams, such as audio, radar, lidar, machine sensor data and the like can also be processed using the present methods.

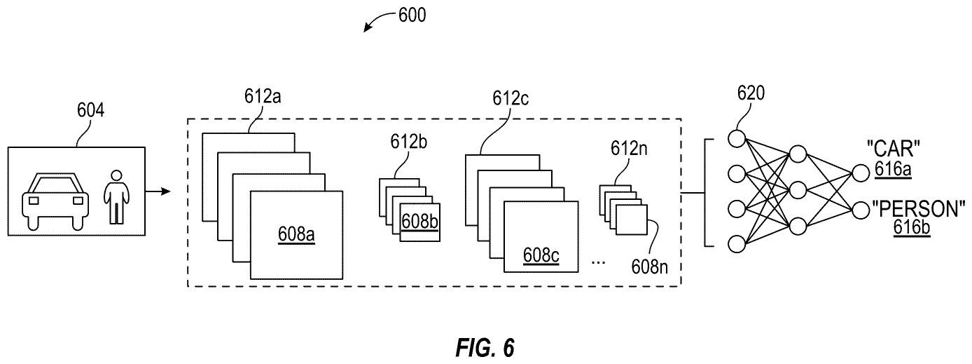

Referring now to FIG. 6 an exemplary optimization process 600 for a loss function for video coding for machines is illustrated by way of a block diagram. Process 600 illustrates a functional application of this technology where feature extraction may be used for downstream object recognition by a machine. For instance, an exemplary input image 604 may include a person and a car. Input image 604 may be received by a feature extractor. In some cases, feature extractor may include a feature extraction machine learning process. In some cases, feature extraction machine learning process may include a convolutional neural network. In some cases, feature extractor may generate multiple sets of feature maps 608a-n. For instance, each set of feature maps 608a-n may correspond with different layers 612a-n of feature extraction. Each layer 612a-n may correspond with different levels of abstraction. For instance, in some cases, input image 604 may include an array having a width and a height (W×H). A first layer 612a may include a first convolutional layer and may yield first feature maps 608a having a first convolutional width and a first convolutional height (C1_W×C1_H). A second layer 612b may include a first pooling layer and may yield second feature maps 608b having a first pooling width and a first pooling height (P1_W×P1_H). A third layer 612c may include an nth convolutional layer and may yield third feature maps 608c having an nth convolutional width and an nth convolutional height (Cn_W×Cn_H). A fourth layer 612n may include an nth pooling layer and may yield fourth feature maps 612n having an nth pooling width and an nth pooling height (Pn_W×Pn_H).

With continued reference to FIG. 6, in some case, one or more of feature extractor and/or machine may take an input picture 604 and output an identification of a car and/or a person, for instance is one or more of car and person are within the input picture 604. As described above, feature extractor may transform input image 604 into feature maps 608a-n, for example by using convolution and subsequent pooling. In some cases, a last pooled layer 608n may be passed as an input (e.g., vector input) to a machine learning process. In some cases, machine learning process may be intended yield a machine learning model for operation on a machine, for instance a machine ultimately downstream of a VCM decoder. machine learning process may include an optimization machine learning process. As described above, optimization machine learning process may be used to optimize a loss function.

With continued reference to FIG. 6, in some cases optimization process 600 may include training of one or more of machine learning model 620, feature extraction machine learning model, and/or optimization machine learning model. During training, optimization machine learning process may use a loss function to assign correct feature extraction parameters and/or machine learning parameters associated with machine learning process 620. In some cases, feature extraction parameters may include layer 612a-n parameters or weightings. Loss function may include any loss function described in this disclosure. As a VCM encoder may have a dual task of achieving correct feature representation with a minimal bitstream size, loss function may include a joint loss function (i.e., a total loss function) that includes calculations representative of video compression (e.g., rate-distortion optimization function). In some cases, feature extractor may contain a machine learning model that is trained and optimized with joint loss function. In some embodiments, training (i.e., learning) process can be done offline or online. In some cases, training can be implemented in feature extractor. Alternatively or additionally, training can be implemented at machine (i.e., end-user) side. In the latter case, training may be conducted remotely and optimized parameters may be transmitted to feature extractor and/or machine, for instance as an update.

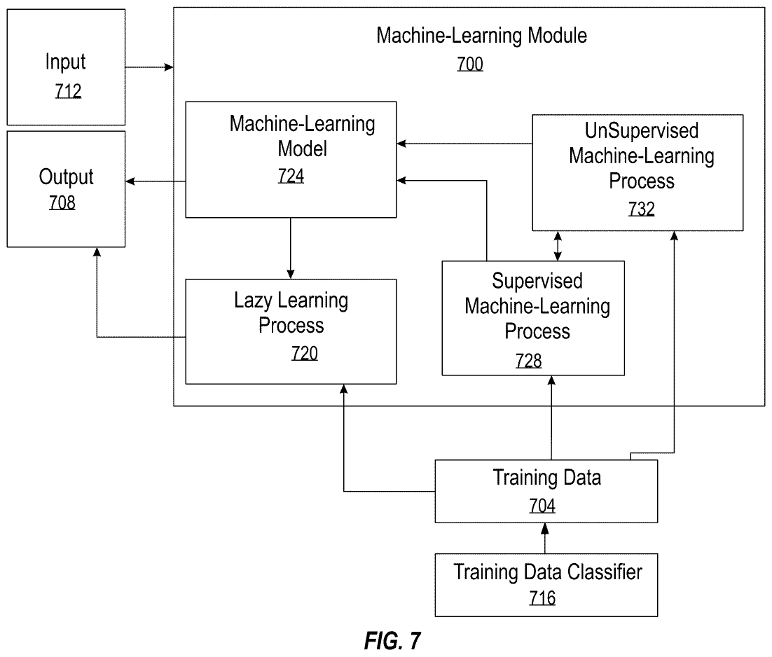

Referring now to FIG. 7, an exemplary embodiment of a machine-learning module 700 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 704 to generate an algorithm that will be performed by a computing device/module to produce outputs 708 given data provided as inputs 712; this is in contrast to a non-machine learning software program where the commands to be executed are determined in advance by a user and written in a programming language.

Still referring to FIG. 7, “training data,” as used herein, is data containing correlations that a machine-learning process may use to model relationships between two or more categories of data elements. For instance, and without limitation, training data 704 may include a plurality of data entries, each entry representing a set of data elements that were recorded, received, and/or generated together; data elements may be correlated by shared existence in a given data entry, by proximity in a given data entry, or the like. Multiple data entries in training data 704 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations; correlations may indicate causative and/or predictive links between categories of data elements, which may be modeled as relationships such as mathematical relationships by machine-learning processes as described in further detail below. Training data 704 may be formatted and/or organized by categories of data elements, for instance by associating data elements with one or more descriptors corresponding to categories of data elements. As a non-limiting example, training data 704 may include data entered in standardized forms by persons or processes, such that entry of a given data element in a given field in a form may be mapped to one or more descriptors of categories. Elements in training data 704 may be linked to descriptors of categories by tags, tokens, or other data elements; for instance, and without limitation, training data 704 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 7, training data 704 may include one or more elements that are not categorized; that is, training data 704 may not be formatted or contain descriptors for some elements of data. Machine-learning algorithms and/or other processes may sort training data 704 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 704 to be made applicable for two or more distinct machine-learning algorithms as described in further detail below. Training data 704 used by machine-learning module 700 may correlate any input data as described in this disclosure to any output data as described in this disclosure. As a non-limiting illustrative example inputs may include input video and/or images and outputs may include known features, such as identifications (e.g., person identification, face identification, and the like).

Further referring to FIG. 7, training data may be filtered, sorted, and/or selected using one or more supervised and/or unsupervised machine-learning processes and/or models as described in further detail below; such models may include without limitation a training data classifier 716. Training data classifier 716 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 700 may generate a classifier using a classification algorithm, defined as a process whereby a computing device and/or any module and/or component operating thereon derives a classifier from training data 704. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 716 may classify elements of training data depending upon the machine or application of machine using VCM encoded video.

Still referring to FIG. 7, machine-learning module 700 may be configured to perform a lazy-learning process 720 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 704. Heuristic may include selecting some number of highest-ranking associations and/or training data 704 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 7, machine-learning processes as described in this disclosure may be used to generate machine-learning models 724. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 724 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 724 may be generated by creating an artificial neural network, such as a convolutional neural network comprising an input layer of nodes, one or more intermediate layers, and an output layer of nodes. Connections between nodes may be created via the process of “training” the network, in which elements from a training data 704 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, machine-learning algorithms may include at least a supervised machine-learning process 728. At least a supervised machine-learning process 728, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include a loss function derived from an encoded feature layer as described above as inputs, and feature extraction parameters as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 704. Persons skilled in the art, upon reviewing the entirety of this disclosure, will be aware of various possible variations of at least a supervised machine-learning process 728 that may be used to determine relation between inputs and outputs. Supervised machine-learning processes may include classification algorithms as defined above.

Further referring to FIG. 7, machine learning processes may include at least an unsupervised machine-learning processes 732. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 7, machine-learning module 700 may be designed and configured to create a machine-learning model 724 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 7, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

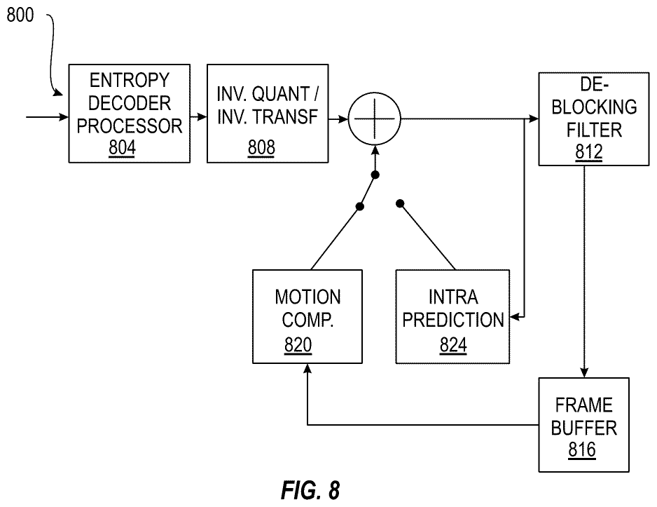

FIG. 8 is a system block diagram illustrating an example decoder 800 generally suitable for decoding video and other coded data, including coded video for VCM applications. Decoder 800 may include an entropy decoder processor 804, an inverse quantization and inverse transformation processor 808, a deblocking filter 812, a frame buffer 816, a motion compensation processor 820 and/or an intra prediction processor 824.

In operation, and still referring to FIG. 8, bit stream 828 may be received by decoder 800 and input to entropy decoder processor 804, which may entropy decode portions of bit stream into quantized coefficients. Quantized coefficients may be provided to inverse quantization and inverse transformation processor 808, which may perform inverse quantization and inverse transformation to create a residual signal, which may be added to an output of motion compensation processor 820 or intra prediction processor 824 according to a processing mode. An output of the motion compensation processor 820 and intra prediction processor 824 may include a block prediction based on a previously decoded block. A sum of prediction and residual may be processed by deblocking filter 812 and stored in a frame buffer 816.

In an embodiment, and still referring to FIG. 8 decoder 800 may include circuitry configured to implement any operations as described above in any embodiment as described above, in any order and with any degree of repetition. For instance, decoder 800 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

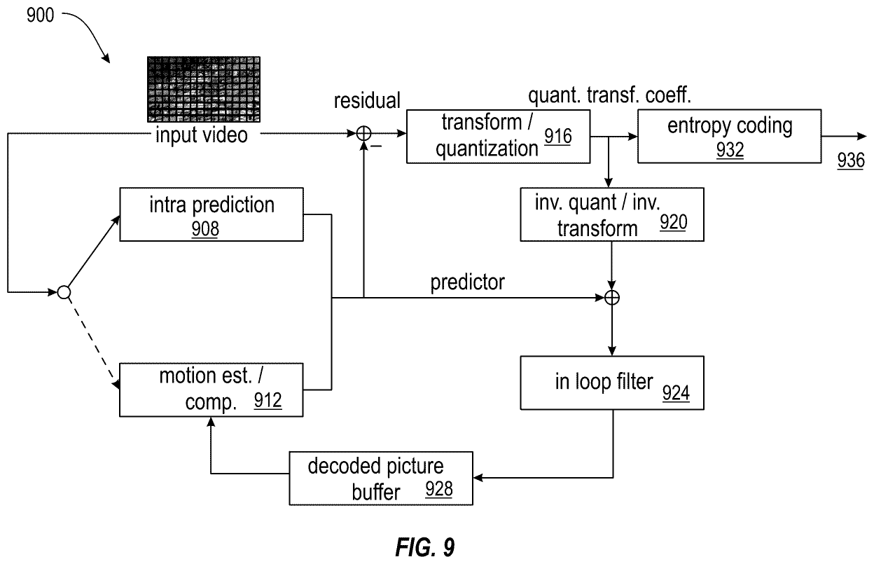

FIG. 9 is a system block diagram illustrating an example video encoder 900 suitable for coding video and other data and suitable for use in VCM applications. Example video encoder 900 may receive an input video 904, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A result of this partitioning may include a group of sub-blocks that may be called predictive units (PU). Transform units (TU) may also be utilized.

Still referring to FIG. 9, example video encoder 900 may include an intra prediction processor 908, a motion estimation/compensation processor 912, which may also be referred to as an inter prediction processor, capable of constructing a motion vector candidate list including adding a global motion vector candidate to the motion vector candidate list, a transform/quantization processor 916, an inverse quantization/inverse transform processor 920, an in-loop filter 924, a decoded picture buffer 928, and/or an entropy coding processor 932. Bit stream parameters may be input to the entropy coding processor 932 for inclusion in the output bit stream 936.

In operation, and with continued reference to FIG. 9, for each block of a frame of input video, whether to process block via intra picture prediction or using motion estimation/compensation may be determined. Block may be provided to intra prediction processor 908 or motion estimation/compensation processor 912. If block is to be processed via intra prediction, intra prediction processor 908 may perform processing to output a predictor. If block is to be processed via motion estimation/compensation, motion estimation/compensation processor 912 may perform processing including constructing a motion vector candidate list including adding a global motion vector candidate to the motion vector candidate list, if applicable.

Further referring to FIG. 9, a residual may be formed by subtracting a predictor from input video. Residual may be received by transform/quantization processor 916, which may perform transformation processing (e.g., discrete cosine transform (DCT)) to produce coefficients, which may be quantized. Quantized coefficients and any associated signaling information may be provided to entropy coding processor 932 for entropy encoding and inclusion in output bit stream 936. Entropy encoding processor 932 may support encoding of signaling information related to encoding a current block. In addition, quantized coefficients may be provided to inverse quantization/inverse transformation processor 920, which may reproduce pixels, which may be combined with a predictor and processed by in loop filter 924, an output of which may be stored in decoded picture buffer 928 for use by motion estimation/compensation processor 912 that is capable of constructing a motion vector candidate list including adding a global motion vector candidate to the motion vector candidate list.

With continued reference to FIG. 9, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 9, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 9, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 9, encoder 900 may include circuitry configured to implement any operations as described above in any embodiment, in any order and with any degree of repetition. For instance, encoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 900 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 9, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 900 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

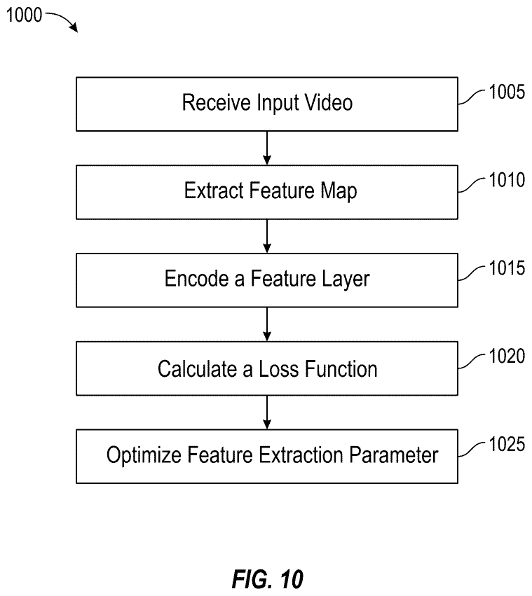

Referring now to FIG. 10, an exemplary method 1000 of optimizing a loss function for video coding for machines is illustrated by way of a flow diagram. At step 1005, method 1000 may include receiving, using a computing device, an input video. Computing device may include any computing device described in this disclosure. Input video may include any video described in this disclosure. In some embodiments, computing device may include one or more of a decoder and an encoder. Decoder may include any decoder described in this disclosure. Encoder may include any encoder described in this disclosure.

With continued reference to FIG. 10, at step 1010 method 1000 may include extracting, using computing device, a feature map as a function of input video and at least a feature extraction parameter. Feature extraction parameter may include any feature extraction parameter described in this disclosure. In some embodiments, extracting feature map may include a feature extraction machine learning process. Feature extraction machine learning process may include any machine learning process described in this disclosure.

With continued reference to FIG. 10, at step 1015, method 1000 may include encoding, using computing device, a feature layer as a function of feature map. Feature layer may include any feature layer described in this disclosure.

With continued reference to FIG. 10, at step 1020, method 1000 may include calculating, using computing device, a loss function as a function of base feature layer. Loss function may include any loss function described in this disclosure, including for example with reference to FIGS. 1-9. In some embodiments, loss function may include a rate-distortion optimization function. In some cases, rate-distortion optimization may aggregate a distortion metric and a compression metric.

With continued reference to FIG. 10, at step 1025, method 1000 may include optimizing, using computing device, at least a feature extraction parameter as a function of loss function. In some embodiments, optimizing feature extraction parameters may include an optimization machine learning process. Optimization machine learning process may include any optimization machine learning process described herein.

Still referring to FIG. 10, in some embodiments, method 1000 may additionally include extracting, using computing device, an optimized feature map as a function of input video and at least an optimized feature extraction parameter, encoding, using the computing device, an optimized feature layer as a function of the optimized feature map, multiplexing, using the computing device, an output bitstream as a function of the optimized feature layer and at least another layer, and transmitting, using the computing device, the output bitstream. output bitstream may include any bitstream described in this disclosure. In some cases, method 1000 may additionally include receiving, using computing device, output bitstream, demultiplexing, using the computing device, optimized feature layer as a function of the output bitstream, and decoding, using the computing device, the optimized feature layer. In some cases, method 1000 additionally includes outputting, using computing device, optimized feature layer to a machine. Machine may include any machine described herein. In some cases, method 1000 may include signaling a machine parameter to machine, wherein the machine parameter is a function of at least an optimized feature extraction parameter.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

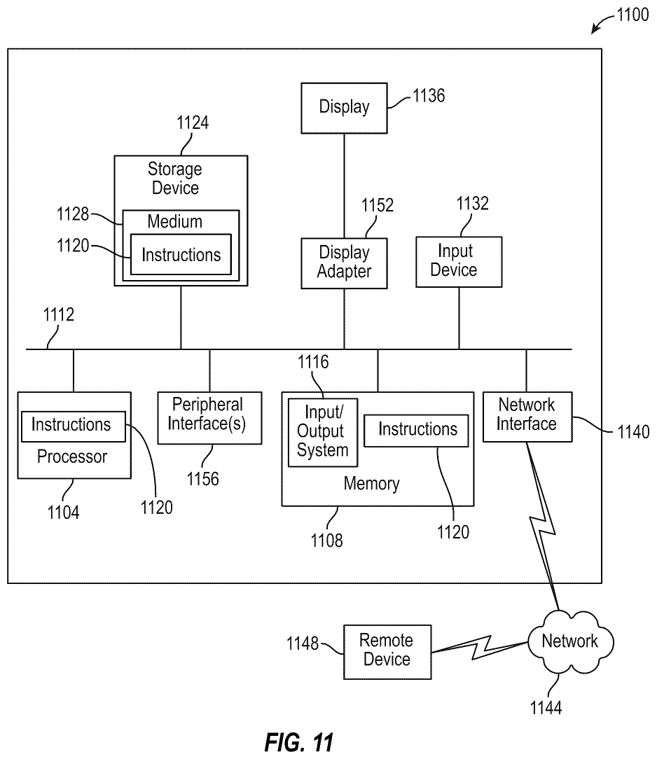

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A decoder for a video coding for machine consumption employing frame augmentation comprising:
a video decoder receiving an encoded bitstream and providing a decoded bitstream comprising a plurality of frames;
a feature extractor module for extracting features and image statistics from the decoded bitstream for machine processing; and
an augmentation module applying the extracted features and image statistics and selectively altering at least a portion of at least one frame of the decoded bitstream to enhance task performance by the machine processing the decoded bitstream.

2. The decoder of claim 1, further comprising a prediction module, said prediction module interposed between the feature extractor module and the augmentation module and providing at least one parameter to the augmentation model indicating whether to selectively apply augmentation for at least one frame of the decoded bitstream.

3. The decoder of claim 2, wherein the prediction model includes a trained neural network evaluating decoded frame attributes including at least one of quantization parameters, motion parameters, block partitioning, and header information describing encoder parameters.

4. The decoder of claim 2, wherein selectively applying augmentation further comprises selectively adjusting the magnitude of feature augmentation for at least one frame of the decoded bitstream.

5. The decoder of claim 1, wherein the extractor module extracts at least one image statistic from the decoded bitstream.

6. The decoder of claim 5, wherein the at least one image statistic includes at least one of statistics related to blur, brightness, color, BRUSQUE, resolution, contrast, and compression.

7. The decoder of claim 1, wherein a frame includes a plurality of coding blocks and wherein the augmentation module performs at least one of sharpening and blurring boundaries between adjacent coding blocks.

8. The decoder of claim 4, wherein the prediction module further comprises:
acquiring image statistics from the extractor module;
perform image augmentation on a current frame;
performing object detection on an augmented current frame;
determine image mAP higher and mAP lower parameters for the augmented frame;
determining at least one image statistics score; and
applying the image statistics and image statistics score to a trained prediction model and determining at least one mAP performance prediction.

9. A decoder for a video coding for machine consumption employing frame augmentation comprising:
a video decoder receiving an encoded bitstream and providing a decoded bitstream comprising a plurality of frames;
a feature extractor module extracting features and image statistics from the decoded bitstream for machine processing;
a prediction module, said prediction module coupled to the extraction module, receiving image statistics therefrom, and providing at least one parameter to selectively apply augmentation for a at least one frame of the decoded bitstream; and
an augmentation module receiving the at least one parameter from the prediction module and selectively altering at least a portion of at least one frame to enhance task performance by the machine processing the decoded bitstream.

10. The decoder of claim 9, wherein the prediction model includes a trained neural network evaluating decoded frame attributes including at least one of quantization parameters, motion parameters, block partitioning, and header information describing encoder parameters.

11. The decoder of claim 9, wherein the extractor module extracts at least one image statistic from the decoded bitstream.

12. The decoder of claim 11, wherein the at least one image statistic includes at least one of statistics related to blur, brightness, color, BRUSQUE, resolution, contrast, and compression.

13. The decoder of claim 9, wherein a frame includes a plurality of coding blocks and wherein the augmentation module performs at least one of sharpening and blurring boundaries between adjacent coding blocks.

14. The decoder of claim 9, wherein the prediction module further comprises a processor programmed with instructions for:
acquiring image statistics from the extractor module;
performing image augmentation on a current frame;
performing object detection on a augmented current frame;
determine image mAP higher and mAP lower parameters for the augmented frame;
determining at least one image statistics score; and
applying the image statistics and image statistics score to a trained prediction model and determining at least one mAP performance prediction.

15. A method for improving task performance of a machine processing encoded image data, comprising:
receiving an encoded bitstream comprising compressed image data;
decoding the encoded bitstream;
extracting features and image statistics from the decoded bitstream;
evaluating the image statistics to predict whether augmentation of a frame will enhance task performance and generate at least one parameter for selectively applying an augmentation process; and
using the at least one parameter to selectively alter at least a portion of at least one frame to enhance task performance by the machine processing the decoded bitstream.
